(19) United States
(12) Patent Application Publication
(10) Pub. No.: US 2021/0194084 A1
(43) Pub. Date: Jun. 24, 2021

(54) SEALANT FILM FOR BATTERY PACKAGING MATERIAL

(71) Applicant: SHOWA DENKO PACKAGING CO., LTD., Kanagawa (JP)

(72) Inventors: Daisuke NAKAJIMA, Kanagawa (JP); Takashi NAGAOKA, Kanagawa (JP)

(73) Assignee: SHOWA DENKO PACKAGING CO., LTD., Kanagawa (JP)

(21) Appl. No.: 17/132,668

(22) Filed: Dec. 23, 2020

(30) Foreign Application Priority Data
Dec. 24, 2019 (JP) 2019-233091
Nov. 6, 2020 (JP) 2020-185858

(51) Int. Cl. H01M 50/197; H01M 50/198; H01M 50/191; H01M 50/193; B32B 15/085

(52) U.S. Cl. CPC H01M 50/197; H01M 50/198; H01M 50/191; B32B 2457/10; B32B 15/085; B32B 2307/306; H01M 50/193

(57) ABSTRACT

It is intended to improve formability of a battery packaging material. A sealant film 20 for a battery packaging material is a multi-layer material composed of a first non-stretched film layer 21 in which one surface thereof serves as a surface of the innermost layer of the battery packaging material 1, and one or more other non-stretched film layers 22 and 23 laminated on the other surface side of the first non-stretched film layer 21. The first non-stretched film layer 21 contains a random copolymer containing a monomer other than propylene and propylene as a copolymerization component, a homopolymer of propylene, a lubricant, and a content rate of the homopolymer to a total amount of the random copolymer and the homopolymer is 5 wt % to 30 wt %.

### TECHNICAL FIELD

The present invention relates to a sealant film serving as a packaging material for various batteries, and also relates to a battery packaging material using the sealant film as an innermost layer.

### BACKGROUND ART

In recent years, with the thinning and the weight reduction of a mobile electric device, such as, e.g., a smartphone and a tablet terminal, as a packaging material for a storage device, such as, e.g., a lithium-ion secondary battery, a lithium polymer secondary battery, a lithium-ion capacitor, and an electric double layer capacitor, to be mounted on such a mobile electric device, in place of a conventional metallic can, a laminated body composed of a heat resistant resin layer, an adhesive layer, a metal foil layer, and a thermoplastic resin layer (inner sealant layer) is used.

Further, it is increasing to package a power source for an electric vehicle or the like, a large power source for a power storage application, a capacitor, etc., with a laminated body (packaging material) having the above-described configuration. By subjecting the laminated body to stretch forming and/or deep drawing, the laminated body is molded into a three-dimensional shape such as a substantially rectangular parallelepiped shape. By molding into such a three-dimensional shape, it is possible to secure an accommodation space for accommodating a power storage device main body.

In order to form such a three-dimensional shape in good condition without causing pinholes or breakage, it is required to improve the slipperiness of the surface of the inner sealant layer. In order to improve the slipperiness of the surface of the inner sealant layer to ensure good formability, there has been proposed a sealant film in which specific resins are used, and a lubricant amount is regulated in a laminated material in which a packaging resin film, a first adhesive layer, a chemical conversion treatment aluminum foil, a second adhesive layer, and a sealant film are sequentially laminated (see Patent Documents 1 and 2).

The sealant film described in Patent Document 1 is made of a random copolymer of propylene and α-olefin in which the content of the α-olefin is 2 wt % to 10 wt %, and a lubricant of 1,000 ppm to 5,000 ppm is contained in the random copolymer.

The sealant film described in Patent Document 2 is a laminated film composed of a film in which an ethylene-propylene block copolymer film is sandwiched by two ethylene-propylene random copolymer films, and a second polypropylene layer disposed on an inner layer side. A lubricant is added to the second propylene layer.

### PRIOR ART DOCUMENT

### Patent Document

### Patent Document 1: Japanese Unexamined Patent Application Publication No. 2003-288865

### Patent Document 2: Japanese Patent No. 5,211,461

### SUMMARY OF THE INVENTION

### Problems to be Solved by the Invention

However, in the above-described prior art, it is difficult to control the amount of lubricant oozed to the surface by the warming retention time and the storage time in the production process of the packaging material (laminated material). Therefore, good formability cannot be obtained in some cases. In addition, when the lubricant excessively oozes to the surface of the packaging material, the lubricant is adhered and deposited on the molding surface of the molding die to generate powder (white powder by the lubricant). When such white powder adheres to and accumulates on the molding surface, there are problems that the productivity of the packaging material deteriorates by removing the white powder. Thus, there are limitations in improving the formability by a lubricant.

### Means for Solving the Problem

In view of the above-mentioned background, the present invention aims to provide a sealant film for a battery packaging material in which the oozed amount of the lubricant is controlled in an appropriate amount, and also provide a battery packaging material in which the sealant film is arranged as an innermost layer.

In other words, the present invention has the configuration described in the following items [1] to [8].

[1] A sealant film for a battery packaging material, comprising:

a multi-layer material composed of a first non-stretched film layer in which one surface thereof serves as a surface of an innermost layer of a battery packaging material, and another non-stretched film layer composed of one or more layers laminated on the other surface of the first non-stretched film layer,

wherein the first non-stretched film layer comprises:

a random copolymer containing a monomer other than propylene and propylene as a copolymerization component;

a homopolymer of propylene; and

a lubricant,

wherein a content rate of the homopolymer to a total amount of the random copolymer and the homopolymer is 5 wt % to 30 wt %.

[2] The sealant film for a battery packaging material, as recited in the above-described Item [1],

wherein a lubricant concentration in the first non-stretched film layer is 200 ppm to 3,000 ppm.

[3] The sealant film for a battery packaging material, as recited in the above-described Item [1] or [2], wherein the another non-stretched film layer laminated on the other surface of the first non-stretched film layer is a layer composed of a block copolymer containing a monomer other than propylene and propylene as a copolymerization component.

[4] The sealant film for a battery packaging material, as the above-described Item [3],

wherein the another non-stretched film layer comprises a block copolymer containing a monomer other than propylene and propylene as a copolymerization component, and wherein a lubricant concentration in the another non-stretched film layer is 500 ppm to 5,000 ppm.

[5] The sealant film for a battery packaging material, as recited in the above-described Item [1] or [2],

wherein the non-stretched film layer of the battery packaging material bonded to the metal foil layer is a layer comprising a random copolymer containing a monomer other than propylene and propylene as a copolymerization component.

[6] The sealant film for a battery packaging material, as recited in the above-described Item [1] or [2],

wherein the multi-layer material is a three-layer structure in which a third non-stretched film is laminated on the other surface of the first non-stretched film layer via a second non-stretched film layer as an intermediate layer,

wherein the second non-stretched film layer is a layer comprising a block copolymer containing a monomer other than propylene and propylene as a copolymerization component, and

wherein the third non-stretched film layer is a layer comprising a random copolymer containing a monomer other than propylene and propylene as copolymerization component.

[7] A battery packaging material, comprising:

a heat resistant resin layer;

the sealant film for a battery packaging material as recited in the above-described Item 1 or 2; and

a metal foil layer disposed between the heat resistant resin layer and the sealant film.

[8] The battery packaging material as recited in the above-described Item [7],

wherein, after aging, an oozed amount of a lubricant present on a surface of the first non-stretched film layer of the sealant film for a battery packaging material is 0.2 μg/cm² to 1.0 μg/cm².

### Effects of the Invention

The sealant film as recited in the above-described Item [1] is a multi-layer material, and the resin constituting the first non-stretched film layer serving as the innermost layer of the battery packaging material is a mixture of a random copolymer and a homopolymer of propylene. Therefore, the crystal property becomes high and the rigidity becomes high. Thus, the battery packaging material is reinforced by the first non-stretched film layer to improve the formability. Further, the increased crystal property controls the lubricant ooze due to aging. Thus, excellent formability can be obtained while preventing excessive deposition of white powder.

In the sealant film as recited in the above-described Item [2], since the lubricant concentration is regulated to 200 ppm to 3,000 ppm, the battery packaging material using this sealant film is particularly excellent in formability.

In the sealant film as recited in the above-described Item [3], since the layer containing a block copolymer of propylene is included as a layer other than the first non-stretched film layer, the toughness of the sealant film is increased. Thus, the formability of the battery packaging material using this sealant film is further improved.

In the sealant film as recited in the above-described Item [4], since the lubricant concentration in the layer containing a block copolymer of propylene is regulated to 500 ppm to 5,000 ppm, the battery packaging material using the sealant film is particularly excellent in formability.

In the sealant film as recited in the above-described Item [5], since a layer containing a propylene random copolymer is included on the side bonded to the metal foil layer of the battery packaging material, the adhesion to the metal foil layer is high.

In the sealant film as recited in the above-described Item [6], since the resin constituting the first non-stretched film layer serving as the innermost layer of the battery packaging material is a mixture of a random copolymer of propylene and a homopolymer, the oozed amount of the lubricant is controlled to an appropriate amount. The resin constituting the third non-stretched film layer is a random polymer of propylene, and therefore high adhesion to the metal foil layer can be obtained. The resin constituting the second non-stretched film layer of the intermediate layer is a block copolymer of propylene, and therefore high toughness can be obtained.

In the battery packaging material as recited in the above-described Item [7], since the oozed amount of the lubricant is controlled to an appropriate amount by the first non-stretched film layer of the sealant film serving as the innermost layer, the formability is improved.

In the battery packaging material as recited in the above-described Item [8], since the lubricant of 0.2 μg/cm² to 1.0 μg/cm² is oozed to the surface of the first non-stretched film of the sealant film for a battery packaging material, there is no excessive occurrence of white powder and the formability is excellent.

### BRIEF DESCRIPTION OF THE DRAWINGS

FIG. 1 is a cross-sectional view of a battery packaging material using a sealant film of the present invention.

FIG. 2 is a perspective view of a battery packaging body using the battery packaging material of FIG. 1.

### EMBODIMENTS FOR CARRYING OUT THE INVENTION

### [Sealant Film and Battery Packaging Material]

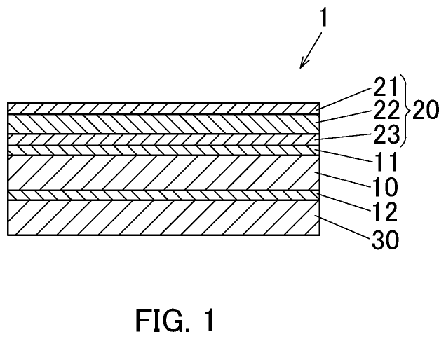

FIG. 1 shows an embodiment of a battery packaging material of the present invention.

The battery packaging material 1 is a laminate material in which a sealant film 20 is laminated on one surface of a metal foil layer 10 as a barrier layer via a first adhesive layer 11, and a heat resistant resin layer 30 is laminated on the other surface of the metal foil layer 10 via a second adhesive layer 12. The sealant film 20 is an embodiment of a sealant film for a battery packaging material of the present invention. In the following description, the term “sealant film for a battery packaging material” is sometimes abbreviated as “sealant film”.

The sealant film 20 is a three-layered material in which a first non-stretched film layer 21, a second non-stretched film layer 22, and a third non-stretched film layer 23 are sequentially laminated. The third non-stretched film layer 23 is bonded to the metal foil layer 10 by an adhesive layer 11. Therefore, the first non-stretched film layer 21 is the innermost layer of the battery packaging material 1, and the surface of the first non-stretched film layer 21 opposite to the second non-stretched film layer 22 is exposed to serve as a surface of the battery packaging material 1.

The first non-stretched film layer 21 contains a random copolymer containing a monomer other than propylene and propylene as copolymerization component (hereinafter abbreviated as “random copolymer”), a homopolymer of propylene (hereinafter abbreviated as “homopolymer”), and a lubricant.

When a homopolymer is added to a random copolymer, the crystallinity becomes higher than that of the random copolymer alone, and therefore the stiffness becomes higher. Therefore, when the first non-stretched film layer 21 containing a random copolymer and a homopolymer is included in the sealant film 20 to be laminated on the metal foil layer 10, the metal foil layer 10 is reinforced and becomes hardly cracked. Thus, the formability of the battery packaging material 1 is improved.

The above-described “copolymerization component other than propylene” is not particularly limited, and the examples thereof include butadiene and the like, in addition to olefinic components such as ethylene, 1-buten, 1-hexen, 1-penten, and 4 methyl-1-penten. In addition, the content rate of other copolymerization components except for propylene in the above-described random copolymer is preferably in the range of 0.5 wt % to 20 wt %, and particularly preferably in the range of 1 wt % to 10 wt %.

The content rate of the homopolymer to the total amount of the random copolymer and the homopolymer is 5 wt % to 30 wt %. This is because when the content rate of the homopolymer is less than 5 wt %, the formability improving effect is small, and when it exceeds 30 wt %, there is a possibility that the sealant flows due to the high crystal property and the increase in the sealing temperature. The particularly preferred content rate of the homopolymer is from 5 wt % to 15 wt %.

Further, the lubricant used in the first non-stretched film layer 21 is not particularly limited, and examples thereof include saturated fatty acid amides, unsaturated fatty acid amides, substituted amides, methylolamides, saturated fatty acid bisamides, unsaturated fatty acid bisamides, fatty acid ester amides, and aromatic bisamides.

Examples of such saturated fatty acid amides include, but are not limited to, lauric acid amide, palmitic acid amide, stearic acid amide, behenic acid amide, and hydroxistealic acid amide. The unsaturated fatty acid amide is not particularly limited, and examples thereof include oleic acid amide and erucic acid amide.

The substituted amide is not particularly limited, and includes, for example, N-oleyl palmitic acid amide, N-stearyl stearic acid amide, N-stearyl oleic acid amide, N-oleyl stearic acid amide, N-stearyl erucic acid amide, and the like. Further, the methylolamide is not particularly limited, and examples thereof include methylol stearic acid amide and the like.

The saturated fatty acid bisamide is not particularly limited, and examples thereof include methylene bis stearic acid amide, ethylene bis capric acid amide, ethylene bis lauric acid amide, ethylene bis stearic acid amide, ethylene bis hydroxy stearic acid amide, ethylene bis behenic acid amide, hexamethylene bis stearic acid amide, hexamethylene bis behenic acid amide, hexamethylene hydroxy stearic acid amide, N, N′-distearyl adipic acid amide, N, N′-distearyl sebacic acid amide, and the like.

Examples of the unsaturated fatty acid bisamide include, but are not limited to, ethylene bis oleic acid amide, ethylene bis erucic acid amide, hexamethylene bis oleic acid amide, N, N′-dioleylsebacic acid amide, and the like.

The fatty acid ester amide is not particularly limited, and examples thereof include stearoamide ethyl stearate and the like.

The aromatic bisamide is not particularly limited, and examples thereof include m-xylylenebis stearic acid amide, m-xylylenebis hydroxystearic acid amide, and N, N′-cystearyl isophthalic acid amide.

The lubricant concentration in the first non-stretched film layer is preferably in the range of 200 ppm to 3,000 ppm. When the lubricant content is less than 200 ppm, formability is insufficient, and when 3,000 ppm is added, formability is sufficiently improved. Therefore, a large amount exceeding this amount is not preferable from the viewpoint of costs. The particularly preferred lubricant concentration is 500 ppm to 2,000 ppm.

Further, as described above, the first non-stretched film layer 21 is high in crystallinity due to the mixture of the homopolymer. When the laminated body bonded in the production process of the battery packaging material 1 is subjected to an aging treatment, the lubricant contained in the first non-stretched film layer 21 oozes to the surface of the film. However, since the crystallinity of the first non-stretched film layer 21 is high, the lubricant will not be excessively oozed. Therefore, in the first non-stretched film, the oozed amount of the lubricant is controlled by the high crystallinity due to the homopolymer, and an excellent formability is obtained while preventing excessive occurrence of white powder.

An anti-blocking agent may be contained in the first non-stretched film layer 21. The anti-blocking agent is not specifically limited, and the examples thereof include, silica particles, acrylic resin particles, and aluminum silicate particles. The particle size of the anti-blocking agent is preferably in the range of 0.1 μm to 10 μm in the average particle diameter, and more preferably in the range of 1 μm to 5 μm in the average particle diameter. The content concentration of the anti-blocking agent in the first non-stretched film layer 21 is preferably set to 100 ppm to 5,000 ppm. Further, the anti-blocking agent may be contained in layers other than the first non-stretched film layer.

By containing the anti-blocking agent (particles) in the first non-stretched film layer 21 forming the innermost layer of the battery packaging material 1, it is possible to form micro projections on the surface of the innermost layer and reduce the contact area between the films to suppress blocking between sealant films. Further, by containing the anti-blocking agent (particles) together with a lubricant, it is possible to further improve the slipperiness at the time of molding.

The sealant film of the present invention is a multi-layer material including one or more layers of a non-stretched film layer in addition to the first non-stretched film layer described above.

As the resin constituting other non-stretched film layers, a block copolymer containing a monomer other than propylene and propylene as a copolymerization component (hereinafter abbreviated as “block copolymer”) can be recommended. The above-described “other copolymerization component other than propylene” is not particularly limited, and examples thereof include olefinic components such as ethylene, 1-buten, 1-hexen, 1-penten, and 4 methyl-1-penten, and elastomeric components such as butadiene and the like and further ethylene-propylene copolymer rubber by an olefin-based resin. The content rate of other copolymerization component excluding propylene in the above-described block copolymer is preferably in the range of 10 wt % to 30 wt %, and particularly preferably in the range of 10 wt % to 20 wt %.

By adding a layer containing a block copolymer to the layer constituting the sealant film, toughness is increased and formability is further improved. In addition, a lubricant is also preferably contained in this non-stretched film layer, and the lubricant concentration is preferably 500 ppm to 5,000 ppm. This is because when the lubricant concentration is less than 500 ppm, the amount of lubricant acting on the surface is insufficient, so that the slipperiness is deteriorated, and when the concentration is more than 5,000 ppm, a large amount of precipitation occurs on the surface, which increases the possibility of contaminating the surroundings. The particularly preferred lubricant concentration is 700 ppm to 3,000 ppm. The lubricant used for layers containing a block copolymer conforms to the lubricant used in the first non-stretched film layer.

In the sealant film, the layer bonded to the metal foil layer is preferably composed of a layer higher in adhesiveness to the metal foil layer. The random copolymer which is one of the resin components of the first non-stretched film layer, that is, the random copolymer which contains a monomer other than propylene and propylene as a copolymerization component is a resin high in adhesion to the metal foil layer, and it is preferable that the layer on the metal foil layer side is composed of a layer containing a random copolymer. When a lubricant is contained in the layer of the random copolymer, it is preferable that the concentration is within a range that does not inhibit adhesion to the metal foil layer, and the lubricant concentration is preferably 50 ppm to 1,000 ppm. In addition, the random copolymer and the lubricant in the layers containing a random copolymer to be placed on the metal foil layer side conform to the random copolymer and the lubricant in the first non-stretched film layer.

### (Sealant Film of Three-Layer Structure)

In the sealant film 20 of three-layer structure of FIG. 1, the second non-stretched film layer 22 of the intermediate layer is formed of a layer containing the block copolymer described above, and the third non-stretched film layer to be bonded to the metal foil layer 10 is formed of a layer containing the random copolymer described above. By arranging the second non-stretched film layer 22 containing a lubricant as the intermediate layer, it becomes easy to control the lubricant amount to be oozed from the surface of the first non-stretched film layer 21, and excessive deposition of white powder can be suppressed. Further, it is preferable to use the above-described block copolymer as the resin constituting the second non-stretched film layer 22, which increases the toughness of the sealant film 20 to improve the formability of the battery packaging material 1. As the resin constituting the third non-stretched film layer 23, it is preferable to use the above-described random copolymer. In this case, high adhesion to the metal foil layer 10 can be obtained.

The preferred thickness of the sealant film of the present invention is 20 μm to 100 μm, and particularly preferably 20 μm to 80 μm. Further, in the sealant film 20 of the three-layer structure described above, a ratio of the preferable thickness of each layer is 5% to 20% for the first non-stretched film layer 21, 60% to 90% for the second non-stretched film layer 22, and 5% to 20% for the third non-stretched film layer 23.

Note that the sealant film of the present invention is not limited except that one surface of the first non-stretched film layer is an exposed multi-layer material, and the number of layers is not limited. Also, the constituent materials of the layers other than the first non-stretched film layer are not limited to the above-described recommended materials of the second non-stretched film layer and the third non-stretched film layer.

### [Production Method of Sealant Film and Battery Packaging Material]

The sealant film 20 is preferably produced by a molding method, such as, e.g., multi-layer extrusion molding, blow molding, and T-die cast film molding.

The battery packaging material 1 can be produced by bonding the third non-stretched film layer 23 of a sealant film 20 to one surface of the metal foil layer 10 via the first adhesive layer 11 and bonding the heat resistant resin layer 30 to the other surface via the second adhesive layer 12. The order of bonding is not limited. Further, it is preferable to perform aging after bonding all the layers to cause precipitation of the lubricant on the surface of the sealant film 20, that is, the surface of the first non-stretched film layer 21. As the aging condition, a heat treatment for maintaining at 50° C. or lower can be recommended. When the aging temperature exceeds 50° C., the lubricant excessively oozes, and a solidified lubricant called white powder is more likely to contaminate the surroundings. Although the aging time is not limited, since the adhesive agent is cured by aging, the aging time is set in consideration of the curing time of the adhesive agent to be used.

In the aged battery packaging material 1, the amount of the lubricant oozed to the surface of the first non-stretched film layer 21 of the sealant film 20, i.e., the amount of the lubricant present on the surface of the innermost layer of the battery packaging material 1, is preferably in the region of 0.2 μg/cm² to 1.0 μg/cm². By setting the oozed amount of the lubricant in the above-described range, it is possible to exhibit good slipperiness at the time of molding and prevent white powder from appearing. A particularly preferred oozed amount of the lubricant on the surface of the first non-stretched film layer 21 is 0.4 μg/cm² to 0.8 μg/cm².

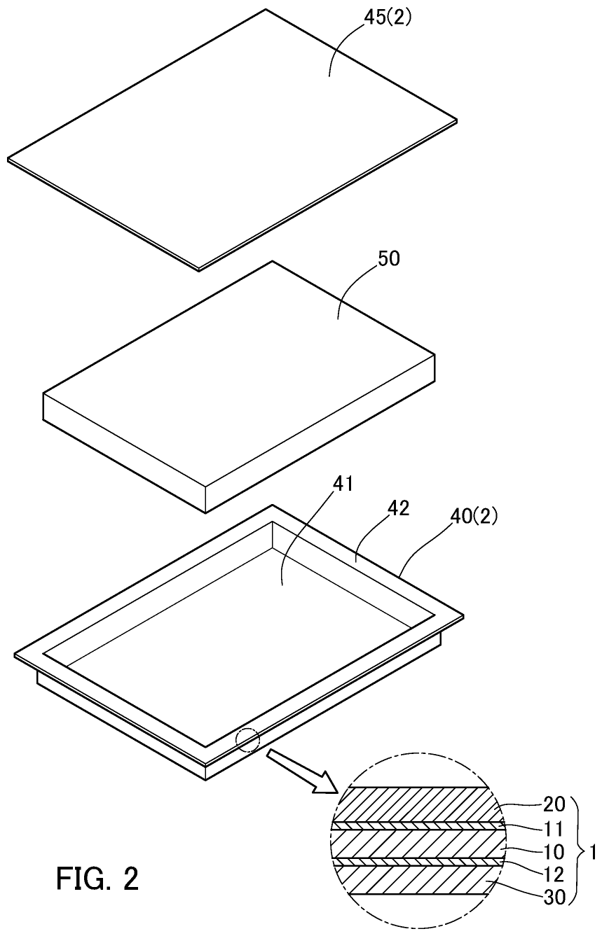

FIG. 2 shows a battery packaging body 2 produced by the battery packaging material 1 of the present invention.

The packaging body 2 is composed of a three-dimensional body 40 and a flat lid plate 45. The body 40 has a recess 41 of a rectangular shape in a plan view and a flange 42 extending outwardly from the opening edge of the recess 41. The lid plate 45 has the same dimensions as that of the outer periphery of the flange 42 of the body 40. The space surrounded by the recess 41 and the lid plate 45 forms an accommodation space for a bare cell 50.

The body 40 of the packaging body 2 is formed by subjecting a battery packaging material 1 of a flat sheet to plastic deformation processing, such as, e.g., stretch forming and deep drawing, to form the recess 41 and trimming the undeformed portion around the periphery of the recess 41 to the outer circumference dimension of the flange 42. When forming the recess 41, plastic deformation is performed so that the sealant film 20 of the battery packaging material 1 becomes the inner surface of the recess 41 and the heat resistant resin layer 30 becomes the outer surface of the recess 41. Since the sealant film 20 is high in strength and excellent in slipperiness due to the action of the lubricant oozed to the surface, a deep recess 41 can be formed by plastic deformation processing. The lid plate 45 is formed by cutting a battery packaging material 1 of a flat sheet into required dimensions.

In the battery packaging material of the present invention, well-known materials other than the sealant film can be used as appropriate, and bonding methods are not particularly limited. Hereinafter, preferred materials of layers excluding the sealant film will be described.

The metal foil layer 10 is responsible for providing the battery packaging material 1 with a gas barrier property for preventing oxygen/water from entering. The metal foil layer 10 is not particularly limited. Examples thereof include an aluminum foil, a SUS foil (stainless steel foil), a copper foil, and the like. Among them, it is preferable to use an aluminum foil, or a SUS foil (stainless steel foil). Preferably, the thickness of the metal foil layer 10 is 5 μm and 120 μm. When the thickness is 5 μm or more, pinhole generation at the time of rolling when producing the metal foil can be prevented, and when the thickness is 120 μm or less, stresses at the time of stretch forming or drawing or the like can be reduced, which in turn can improve the formability. Among these, the thickness of the metal foil layer 10 is more preferably 10 μm to 80 μm.

In the metal foil layer 10, at least the surface on the side of the sealant film 20 is subjected to a chemical conversion treatment. Such chemical conversion treatment can sufficiently prevent the surface of the metal foil from being corroded by the contents (such as an electrolyte of a battery). For example, a metal foil is subjected to a chemical conversion treatment by the following processing. In other words, for example, a surface of a metal foil subjected to a degreasing treatment is coated with any one of 1) to 3) aqueous solutions and then subjected to drying to perform a chemical conversion treatment.

1) an aqueous solution of a mixture containing phosphoric acid, chromic acid, at least one compound selected from the group consisting of a metal salt of fluoride and a non-metal salt of fluoride

2) an aqueous solution of a mixture containing phosphoric acid, at least one resin selected from the group consisting of an acryl-based resin, a chitosan derivative resin, and a phenol-based resin, and at least one compound selected from the group consisting of chromic acid and chromium (III) salt

3) an aqueous solution of a mixture containing phosphoric acid, at least one resin selected from the group consisting of an acryl-based resin, a chitosan derivative resin, and a phenol-based resin, at least one compound containing chromic acid and chromium (III) salt, and at least one compound selected from the group consisting of metal salt of fluoride and non-metal salt

In the chemical conversion coating film, the chromium adhesion amount (per one side) is preferably 0.1 mg/m² to 50 mg/m², more particularly 2 mg/m² to 20 mg/m².

As the heat resistant resin constituting the heat resistant resin layer 30, a heat resistant resin that does not melt at heat sealing temperatures at which the packaging material is heat-sealed is used. As the heat resistant resin, a resin having a melting point higher than the melting point of the resin constituting the sealant film 20 by 10° C. or more, preferably 20° C. or more, is used. Examples of the resin satisfying this condition include a polyamide film such as a nylon film and a polyester film, and these stretched films are preferably used. Among these, as the heat resistant resin layer 30, it is particularly preferable to use a biaxially stretched polyamide film such as a biaxially stretched nylon film, a biaxially stretched polybutylene terephthalate (PBT) film, a biaxially stretched polyethylene terephthalate (PET) film, or a biaxially stretched polyethylene naphthalate (PEN) film. The nylon film is not particularly limited, and examples thereof include a 6 nylon film, a 6, 6 nylon film, and an MXD nylon film. Note that the heat resistant resin layer 30 may be formed of a single layer or may be formed of a multi-layer (such as a multi-layer made of a PET film/a nylon film) made of, for example, a polyester film/a polyamide film.

The thickness of the heat resistant resin layer 30 is preferably from 2 μm to 50 μm. In the case of using a polyester film, the thickness is preferably 2 μm to 50 μm, and in the case of using a nylon film, the thickness is preferably 7 μm to 50 μm. By setting the above-described preferable lower limit value or more, a sufficient strength can be secured as a packaging material, and by setting the above-described preferable upper limit value or less, stresses at the time of forming such as stretch forming and drawing can be reduced, and therefore formability can be improved.

As the adhesive agent constituting the first adhesive layer 11, an olefin-based adhesive agent, an epoxy-based adhesive agent, or the like, can be recommended.

As the adhesive agent constituting the second adhesive layer 12, a urethane-based adhesive agent, an olefin-based adhesive agent, an epoxy-based adhesive agent, an acryl-based adhesive agent, or the like, can be recommended.

### EXAMPLES

A sealant film 20 and a battery packaging material 1 of a three-layer structure shown in FIG. 1 were prepared.

Materials common to the battery packaging materials Examples 1 to 14 and Comparative Examples 1 and 2 are as follows.

As the metal foil layer 10, a metal foil layer obtained by applying a chemical conversion treatment liquid composed of phosphoric acid, polyacrylic acid (acryl-based resin), a chromium (III) salt compound, water, and alcohol on both surfaces of an aluminum foil having a thickness of 40 μm, and then subjecting it to drying at 180° C. to form a chemical conversion coating film was used. The chromium adhesion amount of this chemical conversion coating film was 10 mg/m² per one side.

As the heat resistant resin layer 30, a biaxially oriented 6-nylon film having a thickness of 25 μm was used.

As the first adhesive layer 11, a two-part curing type maleic acid-modified propylene adhesive agent was used. The above-described two-part curing type maleic acid-modified polypropylene adhesive agent was an adhesive agent solution in which 100 parts by mass of maleic acid-modified polypropylene (melting point: 80° C., acid value: 10 mgKOH/g) as a main agent, 8 parts by mass of isocyanurate form (NCO content rate: 20 mass %) of hexamethylene diisocyanate as a curing agent, and a solvent were mixed. The application amount of the adhesive agent solution was 2 g/m² as a solid component amount.

As the second adhesive layer 12, a urethane-based adhesive agent of a two-part curing type was used.

The materials common to the three layers of sealant films in Examples 1 to 14 and Comparative Examples 1 and 2 are as follows:

As a random copolymer containing monomers other than propylene and propylene as copolymerization components, an ethylene-propylene random copolymer was used. The ethylene content in the random copolymer was 5 wt %.

As the block copolymer containing a monomer other than propylene and propylene as a copolymerization component, an ethylene-propylene block copolymer was used. The ethylene content in the block copolymer was 20 wt %.

As the lubricant, erucic acid amide was used for Examples 1 to 11, 13, 14 and Comparative Examples 1 and 2, and behenic acid amide was used for Example 12.

As the anti-blocking agent, silica grains having an average particle diameter of 0.5 μm were used.

Further, the total thickness of the sealant film 20 and the thickness of the three layers of Examples 1 to 14 and Comparative Examples 1 and 2 were common, and the total thickness was 40 μm in thickness, the first non-stretched film layer 21 was 6 μm in thickness, the second non-stretched film layer 22 was 28 μm in thickness, and the third non-stretched film layer 23 was 6 μm in thickness.

### [Fabrication of Sealant Film and Battery Packaging Material]

In the sealant film of Examples 1 to 14 and Comparative Example 2, the resin composition constituting the first non-stretched film layer 21 contained a random copolymer and a homopolymer in the proportions described in Table 1, and further contained a lubricant and an anti-blocking agent at the concentrations described in Table 1 Further, the resin composition constituting the first non-stretched film layer 21 of the sealant film of Comparative Example 1 was made of a random copolymer, a lubricant, and an anti-blocking agent. The resin composition constituting the second non-stretched film layer 22 was composed of a block copolymer and a lubricant in all Examples, and the lubricant concentration of each Example was as shown in Table 1. The third non-stretched film layer 23 was composed of a random copolymer, a lubricant, and an anti-blocking agent in all cases, and the lubricant concentration and the anti-blocking agent concentration were as shown in Table 1.

A second adhesive layer 12 was formed on one side of the metal foil layer 10 to dry the laminate heat resistant resin layer 30. Further, it was prepared to bond the sealant film 20 by forming the first adhesive layer 11 on the opposite surface of the metal foil layer 10.

On the other hand, the sealant film 20 was molded into a laminated material of a three-layer structure by co-extruding a resin composition serving as a material of each layer using a T-die. In the molded sealant film 20, a third non-stretched film layer 23 was stacked on the first adhesive layer 11 of the metal foil layer 10 previously prepared, and the laminate body was sandwiched between a rubber nip roll and a laminate roll heated to 100° C. and dry-laminated to form a battery packaging material 1 of FIG. 1. Next, the prepared battery packaging material 1 was kept at 40° C. for 10 days and aged.

The oozed amount of the lubricant, formability, and white powder of the produced battery packaging material 1 of each sample were evaluated by the following methods. Evaluation results are shown in Table 1.

### (Oozed Amount of Lubricant)

After cutting two rectangular test pieces of 100 mm length×100 mm width from each battery packaging material 1, these two test pieces were stacked and the peripheral portions of the sealant films 20 were heat-sealed at a heat-sealing temperature of 200° C. to produce a bag body. 1 mL of acetone was injected into the inner space of this bag body using a syringe, and it was allowed to stand for 3 minutes in a state in which the surface of the first non-stretched film layer 21 of the sealant film 20 and the acetone were in contact with each other, and then the acetone in the bag body was drawn out. By measuring and analyzing the amount of the lubricant contained in this drawn-out liquid using a gas chromatograph, the amount (μg/cm²) of the lubricant present on the surface of the first non-stretched film layer 21 was determined. That is, the lubricant content of the first non-stretched film layer 21 per 1 cm² surface, which was the innermost layer of the battery packaging material 1, was determined.

The oozed amount of the lubricant was measured twice before and after aging.

### (Formability)

Using a forming depth free straight die, the battery packaging material 1 after aging was deeply drawn in one stage to form a recess, and the largest pinhole (mm) capable of performing good forming with no generation of pinholes at the corners of the recess was investigated. Note that the presence or absence of pinhole was examined by visually observing the presence or absence of the transmission light transmitted through pinholes.

### (Molding Conditions)

Mold: punch: 33.3 mm×53.9 mm, die: 80 mm×120 mm, corner R: 2 mm, punch R: 1.3 mm, die R: 1 mm

Wrinkle pressing pressure: gauge pressure: 0.475 MPa, actual pressure (calculated value): 0.7 MPa

Material: SC (carbon-steel) material, punch R only chrome-plated

Note that the recess formed in the battery packaging material 1 corresponds to the recess 41 of the body 40 of the battery packaging body 2 in FIG. 2, the dimension of the punch of the mold corresponds to the planar dimension of the interior of recess 41, the forming depth corresponds to the depth of the recess 41.

### (White Powder)

After cutting out a rectangular test piece of a length of 600 mm (MD direction)×a width of 100 mm from each battery packaging material after aging, the obtained test piece was placed on a test table with the first non-stretched film layer 21 surface of the sealant film 20 upward. In a state in which a SUS weight (mass: 1.3 kg, size of the ground plane: 55 mm×50 mm) in which a black cloth was wound and the surface was exhibited black was placed on the upper surface of the test piece, the weight was moved over a length of 400 mm with the contact state to the upper surface of the test piece by pulling the tensile speed 4 cm/sec in the horizontal direction parallel to the upper surface of the test piece. The cloth (black) of the contact surface of the weight after the pull was observed visually, and the surface of the cloth (black) had a prominent white powder was evaluated as “X”, and the one that had a certain (medium) white powder was evaluated as “Δ”, and the one that had little white or no white powder was evaluated as “◯”. In this test, however, no test piece was found in the medium (Δ) assessment.

Note that, as the above-described black cloth, the “static electricity removing sheet S SD2525 3100” produced by TRUSCO NAKAYAMA CORPORATION was used.

TABLE 1

| | Sealant film | | | | | | | | | | | |
|---|---|---|---|---|---|---|---|---|---|---|---|---|
| | | | | | Second non- | | | | | | | |
| | | | | | stretched | Third non-stretched | | | Battery packaging material | | | |
| | First non-stretched film layer | | | | film layer | film layer | | | Lubricant | | | |
| | Propylene configuration | | Lubricant | Anti- | Lubricant | Lubricant | Anti- | | oozed amount | | | |
| | ratio (wt %) | | concen- | blocking | concen- | concen- | blocking | *Type | μg/cm² | | | |
| | Random | Homo- | tration | agent | tration | tration | agent | of | Before | After | Formability | While |
| | copolymer | polymer | ppm | ppm | ppm | ppm | ppm | lubricant | aging | aging | mm | powder |
| Ex. 1 | 90 | 10 | 1000 | 2000 | 2500 | 1000 | 2000 | E | 0.3 | 0.7 | 7 | ◯ |
| Ex. 2 | 95 | 5 | 1000 | 2000 | 2500 | 1000 | 2000 | E | 0.3 | 0.8 | 6.5 | ◯ |
| Ex. 3 | 70 | 30 | 1000 | 2000 | 2500 | 1000 | 2000 | E | 0.15 | 0.4 | 6 | ◯ |
| Ex. 4 | 90 | 10 | 200 | 2000 | 2500 | 1000 | 2000 | E | 0.15 | 0.5 | 6 | ◯ |
| Ex. 5 | 90 | 10 | 100 | 2000 | 2500 | 1000 | 2000 | E | 0.1 | 0.4 | 5.5 | ◯ |
| Ex. 6 | 90 | 10 | 3000 | 2000 | 2500 | 1000 | 2000 | E | 0.4 | 0.75 | 7.5 | ◯ |
| Ex. 7 | 90 | 10 | 4000 | 2000 | 2500 | 1000 | 2000 | E | 0.45 | 0.8 | 7.5 | ◯ |
| Ex. 8 | 90 | 10 | 1000 | 2000 | 500 | 1000 | 2000 | E | 0.25 | 0.5 | 6 | ◯ |
| Ex. 9 | 90 | 10 | 1000 | 2000 | 200 | 1000 | 2000 | E | 0.15 | 0.45 | 5.5 | ◯ |
| Ex. 10 | 90 | 10 | 1000 | 2000 | 5000 | 1000 | 2000 | E | 0.35 | 0.75 | 7 | ◯ |
| Ex. 11 | 90 | 10 | 1000 | 2000 | 7000 | 1000 | 2000 | E | 0.4 | 0.8 | 7 | ◯ |
| Ex. 12 | 90 | 10 | 1000 | 2000 | 2500 | 1000 | 2000 | E | 0.25 | 0.6 | 6.5 | ◯ |
| Ex. 13 | 85 | 15 | 3000 | 2000 | 2500 | 1000 | 2000 | E | 0.35 | 0.65 | 7 | ◯ |
| Ex. 14 | 80 | 20 | 3000 | 2000 | 2500 | 1000 | 2000 | E | 0.3 | 0.45 | 5.5 | ◯ |
| Comp. | 100 | 0 | 1000 | 2000 | 2500 | 1000 | 2000 | E | 0.3 | 1.2 | 6.5 | x |
| Ex. 1 | | | | | | | | | | | | |
| Comp. | 60 | 40 | 1000 | 2000 | 2500 | 1000 | 2000 | E | 0.05 | 0.1 | 4 | type |
| Ex. 2 | | | | | | | | | | | | |

*E = Lubricant type: Erucic acid amide, B = Behenic acid amide

From Table 1, it was confirmed that the formability was improved by constituting the first non-stretched film layer with a mixture of a random copolymer and a homopolymer. In addition, comparing Examples 1 to 14 with Comparative Example 1, it can be seen that the formability can be improved without increasing the amount of white power by lubricant by adding a homopolymer to the first non-stretched film layer.

This application claims to Japanese Patent Application No. 2019-233091, filed on Dec. 24, 2019, and Japanese Patent Application No. 2020-185858, filed on Nov. 6, 2020, the disclosures of which are incorporated herein by reference in their entirety.

It is to be understood that the terminology and phraseology used herein is for the purpose of description and not of limitation, and does not exclude any equivalents of the features shown and described herein, and is intended to allow to various modifications within the scope of the present invention as claimed.

### INDUSTRIAL APPLICABILITY

A battery packaging material produced by using a sealant film according to the present invention is used as a packaging material for a power storage device, such as, e.g., a lithium secondary battery (a lithium-ion battery, a lithium polymer battery, or the like), a lithium-ion capacitor, an electric double layer capacitor, and an all-solid-state battery or the like.

### DESCRIPTION OF SYMBOLS

1: Battery packaging material
2: Battery packaging body
10: Metal foil layer
11: First adhesive layer
12: Second adhesive layer
20: Sealant film (sealant film for a battery packaging material)
21: first non-stretched film layer
22: Second non-stretched film layer
23: Third non-stretched film layer
30: Heat resistant resin layer

1. A sealant film for a battery packaging material, comprising:
a multi-layer material composed of a first non-stretched film layer in which one surface thereof serves as a surface of an innermost layer of a battery packaging material, and another non-stretched film layer composed of one or more layers laminated on the other surface of the first non-stretched film layer,
wherein the first non-stretched film layer comprises:
a random copolymer containing a monomer other than propylene and propylene as a copolymerization component;
a homopolymer of propylene; and
a lubricant,
wherein a content rate of the homopolymer to a total amount of the random copolymer and the homopolymer is 5 wt % to 30 wt %.

2. The sealant film for a battery packaging material, as recited in claim 1,
wherein a lubricant concentration in the first non-stretched film layer is 200 ppm to 3,000 ppm.

3. The sealant film for a battery packaging material, as recited in claim 1,
wherein the another non-stretched film layer laminated on the other surface of the first non-stretched film layer is a layer composed of a block copolymer containing a monomer other than propylene and propylene as a copolymerization component.

4. The sealant film for a battery packaging material, as claimed in claim 3,
wherein the another non-stretched film layer comprises a block copolymer containing a monomer other than propylene and propylene as a copolymerization component, and
wherein a lubricant concentration in the another non-stretched film layer is 500 ppm to 5,000 ppm.

5. The sealant film for a battery packaging material, as recited in claim 1,
wherein the non-stretched film layer of the battery packaging material bonded to the metal foil layer is a layer comprising a random copolymer containing a monomer other than propylene and propylene as a copolymerization component.

6. The sealant film for a battery packaging material, as recited in claim 1,
wherein the multi-layer material is a three-layer structure in which a third non-stretched film is laminated on the other surface of the first non-stretched film layer via a second non-stretched film layer as an intermediate layer,
wherein the second non-stretched film layer is a layer comprising a block copolymer containing a monomer other than propylene and propylene as a copolymerization component, and
wherein the third non-stretched film layer is a layer comprising a random copolymer containing a monomer other than propylene and propylene as copolymerization component.

7. A battery packaging material, comprising:
a heat resistant resin layer;
the sealant film for a battery packaging material as recited in claim 1; and
a metal foil layer disposed between the heat resistant resin layer and the sealant film.

8. The battery packaging material as recited in claim 7,
wherein, after aging, an oozed amount of a lubricant present on a surface of the first non-stretched film layer of the sealant film for a battery packaging material is 0.2 μg/cm² to 1.0 μg/cm².
